(19) United States
(12) Patent Application Publication
(10) Pub. No.: US 2014/0262612 A1
(43) Pub. Date: Sep. 18, 2014

(54) MODULAR LADDER PROVIDING FOR UTILITY CONVEYANCE

(71) Applicant: Arthur M. Rabert, Manchester, NH (US)

(72) Inventor: Arthur M. Rabert, Manchester, NH (US)

(21) Appl. No.: 14/109,983

(22) Filed: Dec. 18, 2013

Related U.S. Application Data
(60) Provisional application No. 61/786,814, filed on Mar. 15, 2013.

(51) Int. Cl. E06C 7/14; E06C 7/18; E06C 7/00

(52) U.S. Cl. CPC E06C 7/14; E06C 7/003; E06C 7/188
USPC 182/18; 182/129; 182/107

(57) ABSTRACT

A modular ladder includes interconnectable segments that have utility conduit sections fixed thereto. The conduit sections interconnect to form a utility conduit when the ladder is assembled, thereby allowing safe use of a utility at any ladder height, without the inherent risks and inconvenience of providing a separate conduit. The conduit sections are separated when the ladder is disassembled, thereby saving time, effort, and storage space. In various embodiments, the modular ladder can be configured as any of a step ladder, single ladder, articulated ladder, combination ladder, extension ladder, fixed ladder, mobile ladder stand, and ladder stand platform, among others. Angle-adjusting accessories can enable assembly of the modular ladder in free-standing configurations. Addition of various accessories can provide casters, tilt stabilizers, and trays optimized for various tasks, thereby allowing a user to purchase accessories to expand the modular ladder's capabilities over time.

### RELATED APPLICATIONS

This application claims the benefit of U.S. Provisional Application No. 61/786,814, filed Mar. 15, 2012, which is herein incorporated by reference in its entirety for all purposes.

### FIELD OF THE INVENTION

The invention relates to a modular ladder apparatus, and more particularly, to a modular ladder apparatus providing built-in access to commonly used utilities, such as compressed air, water, paint, and electricity.

### BACKGROUND OF THE INVENTION

Workers use ladders to gain access to otherwise unreachable areas to perform work. Many times, it is necessary for a worker to make use of tools to effectively perform his or her job. These tools frequently require utilities, such as compressed air, water, paint, or electricity in order to function.

Additionally, a worker must generally carry multiple sizes of ladder and scaffolding to be prepared to work at different heights. This takes up space, which can be especially troublesome in a mobile environment where the equipment must be driven from job to job.

With reference to FIGS. 1A through 1C, there currently exist ladders, hereinafter referred to as modular ladders, which can be assembled to various heights by combining a plurality of sections or modules 100. FIG. 1A is a perspective view of a prior art modular ladder section. It incorporates slide fit sections 100 with hollow centers 102 and holes for locking pins to secure sections together 104. FIGS. 1B and 1C present top and front views respectively of the modular ladder section.

With reference to FIG. 2, some existing modular ladders 200 lack any accommodations for utilities. FIG. 2 is a front view, illustrating an assembled prior art modular ladder similar to FIG. 1A, wherein an electrical conduit 202 is hoisted to the top of the ladder 200 by the user and left dangling during use. This approach can cause difficulties in the use of power tools or other equipment while at working height, due to the weight of the cable 202 being pulled by gravity and forces of nature, such as wind. The user is forced to hoist the conduit 202 up while climbing, which creates opportunities for the user to become entangled or possibly to fall, exposes the conduit to wind, and exposes workers on the ground to risk of injury from falling conduits.

With reference to FIG. 3, other modular ladder designs encourage the user to manually run any necessary conduits 202 through hollow sections 300 provided in the ladder side rail as formed by typical modular ladder construction. FIG. 3 is an exploded front view of a ladder 100 of this type, illustrating how an electrical conduit 202 may be run inside of the hollow sections 300.

This approach can make assembly of the modular sections 100 awkward and even dangerous, and does not prevent the conduit 202 from falling and becoming lodged within a hollow section 300. It also prevents the efficient use of space, since this prior art hollow ladder side rail cannot be used for storage of the conduit during transportation, and thus the conduit must be separately stored. This approach also requires the user to spend extra time installing the conduit 202 in the ladder each time the ladder is assembled, and then removing the conduit 202 each time the ladder is disassembled.

What is needed, therefore, is a modular ladder which can provide access to commonly used utilities, without complicating ladder assembly and without requiring additional conduit storage space.

### SUMMARY OF THE INVENTION

The present invention is a modular ladder composed of individual sections, each of which includes at least one built-in conduit segment for conveying a utility to a user of the ladder at working height. The conduit segments terminate in connectors that engage with each other as the ladder is assembled so as to form a complete utility conduit, and disengage from each other when the ladder is disassembled. The conduit segments remain fixed within the ladder sections during transportation, assembly, and use.

In embodiments, the utility conduit provides compressed air, water, paint, electricity, and/or other utilities. In certain embodiments where an electrical conduit is provided, a Ground Fault Circuit Interrupter, or GFCI, is included in at least one of the ladder sections to minimize risk to the user in the case of a short circuit or other fault. In various embodiments, risks arising from use of one or more integrated utilities are mitigated by including a tilt sensor in a ladder section, which prevents the conveyance of utilities through the conduit if the ladder leans beyond a specified angle. The specified angle can be preset during manufacture, or it can be set by the user, in order to provide the highest degree of safety without impeding function. The tilt sensor can be set to cut off the delivery of the utility through the conduit when the ladder tips at an unsafe angle, or when the angle indicates that the ladder is being moved to a different location.

For applications which require a ladder to lean against a structure with enhanced tilt stability, some embodiments provide outriggers which can be secured between modular sections, thus effectively widening the base of the ladder and allowing for use of the ladder at heights that would be unsafe without the outriggers.

Other embodiments of the present invention include a top receptacle that allows connection of two sets of modular sections at an angle, thereby enabling the ladder to stand without further support. In embodiments, the receptacle is adjustable, so as to allow height-appropriate angles to be set by the user. Some of these embodiments also include a pair of modular sections containing lockable hinges, in order to provide increased structural support to the ladder.

Various embodiments further incorporate a shelf, and in some embodiments multiple styles of shelves, into the top receptacle or between modular sections. The shelves can include holders for specific sets of tools, in order to facilitate storage of tools and materials at the working height of the ladder for performance of various tasks that typically require a ladder. For example, the common task of painting can be accommodated by a shelf that is designed to accommodate a paintbrush, a roller, and a can of paint.

Some embodiments provide casters that can be mounted to the bottom of the ladder to facilitate its relocation.

One general aspect of the present invention is a modular ladder including a plurality of interconnectable modular sections, each modular section having a pair of separated, substantially parallel side rails with a substantially perpendicular rung extending therebetween, each of the side rails including a coupling extension for interconnection with side rails of adjacent modular sections, and each of the modular sections having a utility conducting segment cooperative with a side rail thereof, each of the utility conducting segments being terminated at both ends by connectors that are configured to engage with connectors in adjacent utility conducting segments to form a utility conduit when the modular sections are interconnected, the utility conduit enabling communication between a utility source on the ground and a device requiring the utility when used by a worker at height on the modular ladder.

In embodiments, the coupling extension is tapered, thereby facilitating alignment of the coupling extension with a side rail of an adjacent modular section, and insertion of the coupling extension therein.

In some embodiments, the utility conducting segment conveys compressed air, water, paint, or electricity. Other embodiments further include a ground fault circuit interrupter cooperative with an electricity conducting segment of at least one modular section.

In certain embodiments, at least one of the modular segments includes a tilt sensor in communication with a shutoff switch, whereby at least one utility conduit is disabled if the modular segment is tipped beyond a specified angle. And in some of these embodiments the specified angle is selectable by a user.

Various embodiments further include a caster removably connected to the lowest modular section. Some embodiments further include a pair of outriggers configured to widen a base of the modular ladder.

Various embodiments further include a pair of variable angle connecting members, each variable angle connecting member having a pair of side rail connectors joined to each other by an angle adjusting mechanism, the pair of variable angle connecting members being insertable between a pair of adjacent modular sections so as to adjust an angle between the adjacent modular sections, while maintaining continuity of the utility conduit between the adjacent modular sections. And in some of these embodiments the variable angle connecting members are able to fix the angle between the adjacent modular sections at any of a plurality of angular settings.

Another general aspect of the present invention is a modular articulated ladder that includes a plurality of interconnectable modular sections, each modular section having a pair of substantially parallel side rails with a substantially perpendicular rung extending therebetween, each of the side rails including an upper and lower coupling extension for interconnection with side rails of adjacent modular sections, each of the modular sections having a utility conducting segment cooperative with a side rail thereof, each of the utility conducting segments being terminated at both ends by connectors that are configured to engage with connectors in adjacent utility conducting segments to form a utility conduit when the modular sections are interconnected, the utility conduit allowing communication between a utility source on the ground and a device requiring the utility when used by a worker at height on the modular ladder, and a plurality of variable angle connecting members, each variable angle connecting member having a pair of side rail connectors joined to each other by an angle adjusting mechanism, the variable angle connecting members being insertable in pairs between adjacent modular sections so as to adjust an angle between the adjacent modular sections, while maintaining continuity of the utility conduit between the adjacent modular sections, thereby enabling the assembled modular sections joined by said variable angle connectors to be articulated into a plurality of configurations as desired by the user.

In embodiments, the variable angle connecting members are able to fix the angle between the adjacent modular sections at any of a plurality of angular settings.

Some embodiments further include, a pair of horizontal struts, each horizontal strut including two segments joined by a limited hinge, the horizontal struts being attachable between a pair of assembled sets of modular sections joined by a pair of variable angle connecting members so as to limit an angle between the pair of assembled sets of modular sections.

Various embodiments further include a shelf. In some of these embodiments the shelf provides for storage of tools and materials. And in some of these embodiments the tools and materials are selected from the group consisting of paint, brushes, lacquer, shellac, polyurethane, and paint sprayers.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view of a prior art modular ladder section 100;

FIG. 1B is a top view of the prior art modular ladder section 100 of FIG. 1A;

FIG. 1C is a front view of the prior art modular ladder section 100 of FIG. 1A;

FIG. 2 is a front view illustrating an assembled prior art modular ladder 200 similar to FIG. 1A, wherein an electrical conduit 202 has been hoisted to the top of the ladder 200 by a user and left dangling during use;

FIG. 3 is an exploded front view of another prior art modular ladder 300, illustrating how an electrical conduit 202 may be run inside of the hollow sections 102 of the ladder segments;

FIG. 4A is a top view of a single modular section 410 of an embodiment of the present invention that includes an electrical conduit segment 408 permanently installed inside of the modular section, the conduit segment being interconnected into a conduit without further steps upon assembly of the modular section into a ladder;

FIG. 4B is a perspective view of a single modular section 410, illustrating the embodiment shown in FIG. 4A with the male portion of the electrical conduit segment being visible;

FIG. 5 is an exploded front view of two modular sections 410 in an embodiment of the present invention, showing an electrical conduit segment 408 as well as proper orientation of the modular sections 410 for assembly;

FIG. 6 is a close-up view of a base modular section containing a Ground Fault Interrupter Circuit, or GFCI, 600 that cuts the flow of electricity if a short circuit is detected, as well as a tilt sensor 602 in communication with a shut-off switch that prevents the flow of utilities through the conduit when a preset or user defined angle threshold is exceeded;

FIG. 7 is a partially exploded front view of an embodiment of the present invention incorporating outriggers 700 that give the assembled modular ladder sections 410 a wider stance;

FIG. 8A is a perspective view of an embodiment of the present invention incorporating a single pair of modular section connecting members 800 that enable two assembled groups of modular sections 410 to be connected to form a free-standing step-ladder structure, the angle between the two assembled modular sections 410 being limited by a pair of struts 804 that are bendable about limited central hinges 806;

FIG. 8B is a perspective view of an embodiment similar to FIG. 8A, but wherein the angle between the assembled modular sections 410 is fixed by the angle adjusting sections 800, and wherein the embodiment further incorporates a shelf-structure 802 configured to accommodate tools used in various tasks;

FIG. 8C is a perspective view of an embodiment of the present invention incorporating two pair of modular section connecting members 800 that enable three assembled groups of modular sections to be connected to form a free-standing structure; and

FIG. 9 is a partially exploded front view of an embodiment of the present invention showing casters that can be added to the bottom-most modular section.

### DETAILED DESCRIPTION

In FIGS. 4A and 4B, a modular ladder section 410 in an embodiment of the present invention is illustrated as containing an electrical conduit segment 408. As can be seen in FIG. 4B, the modular section 410 in this embodiment includes a pair of separated, substantially parallel side rails 400 with a substantially perpendicular 402 rung extending therebetween. Each of the side rails 400 includes a coupling extension 404 for interconnection with side rails of an adjacent modular section. In the embodiment of FIGS. 4A and 4B, the coupling extentions 404 are shaped so as to be inserted within side rails of an adjacent modular section. In similar embodiments, the coupling extensions 404 are tapered, so that they can be easily aligned with and inserted into the side rails of the adjacent modular section. In the embodiment of FIG. 4B, the coupling extension 404 includes a locking hole 412 into which a locking pin 414 can be inserted to fix the modular section to an adjacent modular section.

A plurality of modular ladder sections 410 can be combined to form a ladder suitable for work at a wide range of heights. Embodiments of the invention also provides for internal conveyance of utilities without the need for additional hardware or any extra assembly and disassembly steps. Typical conduits include, but are not limited to, electrical cables and pneumatic hoses.

The modular sections 410 of an embodiment of the present invention can be assembled into a conventional ladder configuration. As is illustrated in FIG. 5, through normal assembly, and without extra steps, the conduit sections 408 are also simultaneously interconnected to form a complete conduit, allowing for use of the conveyed utility when working on the ladder without the drawbacks of prior art methods discussed above.

In various embodiments, the modular sections 410 of the present invention can be assembled in many different configurations in order to achieve various objectives of the end user. Examples are shown in FIGS. 5-9. A utility conducting segment 408 is incorporated into each modular section 410 of the various embodiments, such that the utility segments 408 are interconnected to form a complete conduit when the modular sections are assembled together.

FIG. 6 illustrates an embodiment that includes a Ground Fault Circuit Interrupter, 600, or “GFCI,” which provides protection to the user by disabling the conveyance of electricity in the event of a fault in the circuit. Also included in this embodiment is a tilt sensor 602, which works in conjunction with a shut-off switch to prevent the conveyance of utilities through the conduit when the assembled ladder leans beyond a specified angle. The specified angle is either predetermined or can set by the user of the ladder, depending upon the embodiment.

FIG. 7 is a partially exploded front view of an embodiment that includes outriggers 700 which enable the assembled ladder to lean against a structure with enhanced tilt stability. The outriggers 700 include base sections 702, lateral extensions 704, vertical stabilizing struts 706, and reconnecting members 708 that can be secured between modular sections 410, thus effectively widening the base of the ladder and allowing use at heights that would be unsafe without the outriggers 700.

With reference to FIGS. 8A through 8C, embodiments of the present invention include modular section connecting members 800 that allow interconnection of two ladder sections at a variable angle. In FIG. 8A, the angle is freely variable, but is limited to a maximum angle by a pair of struts 804 that are jointed by limited hinges 806, thereby enabling the ladder to to form a free standing step-ladder. In the embodiment of FIG. 8B, the modular section connecting members 808 are able to fix the angle between the modular sections at any of a plurality of angles. FIG. 8C illustrates a scaffolding style structure configured using two pair of modular section connecting members 808. These configurations allow an assembled ladder to be used when there is nothing to lean the modular ladder against, and further obviate the need for the user to own and transport multiple ladders.

As shown in FIG. 8B, some embodiments further include at least one shelf 802 that further increases ease of use. The shelf can be a simple flat surface, as is typical for conventional painting ladders, or it can incorporate specialized features for holding items that a user may need while working on the ladder. Typical specialized embodiments provide storage for paint cans, paint brushes, and tools that include tool storage accommodations. In embodiments, the user can select one or more specialized shelves 802 for each use of the ladder, according to the task to be performed.

With reference to FIG. 9, embodiments of the present invention include casters 900 that can be mounted to the bottom of the ladder to facilitate its relocation. FIG. 9 is a partially exploded front view of such an embodiment of the present invention, showing casters 900 added to the bottom-most modular section.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A modular ladder comprising:
a plurality of interconnectable modular sections, each modular section having a pair of separated, substantially parallel side rails with a substantially perpendicular rung extending therebetween;
each of the side rails including a coupling extension for interconnection with side rails of adjacent modular sections; and
each of the modular sections having a utility conducting segment cooperative with a side rail thereof, each of the utility conducting segments being terminated at both ends by connectors that are configured to engage with connectors in adjacent utility conducting segments to form a utility conduit when the modular sections are interconnected, the utility conduit enabling communication between a utility source on the ground and a device requiring the utility when used by a worker at height on the modular ladder.

2. The modular ladder of claim 1, wherein the coupling extension is tapered, thereby facilitating alignment of the coupling extension with a side rail of an adjacent modular section, and insertion of the coupling extension therein.

3. The modular ladder of claim 1 wherein the utility conducting segment conveys compressed air, water, paint, or electricity.

4. The modular ladder of claim 1, further comprising a ground fault circuit interrupter cooperative with an electricity conducting segment of at least one modular section.

5. The modular ladder of claim 1, wherein at least one of the modular segments includes a tilt sensor in communication with a shutoff switch, whereby at least one utility conduit is disabled if the modular segment is tipped beyond a specified angle.

6. The modular ladder of claim 5, wherein the specified angle is selectable by a user.

7. The modular ladder of claim 1, further comprising a caster removably connected to the lowest modular section.

8. The modular ladder of claim 1, further comprising a pair of outriggers configured to widen a base of the modular ladder.

9. The modular ladder of claim 1, further comprising a pair of variable angle connecting members, each variable angle connecting member having a pair of side rail connectors joined to each other by an angle adjusting mechanism, the pair of variable angle connecting members being insertable between a pair of adjacent modular sections so as to adjust an angle between the adjacent modular sections, while maintaining continuity of the utility conduit between the adjacent modular sections.

10. The modular articulated ladder of claim 9, wherein the variable angle connecting members are able to fix the angle between the adjacent modular sections at any of a plurality of angular settings.

11. A modular articulated ladder comprising:
a plurality of interconnectable modular sections, each modular section having a pair of substantially parallel side rails with a substantially perpendicular rung extending therebetween;
each of the side rails including an upper and lower coupling extension for interconnection with side rails of adjacent modular sections;
each of the modular sections having a utility conducting segment cooperative with a side rail thereof;
each of the utility conducting segments being terminated at both ends by connectors that are configured to engage with connectors in adjacent utility conducting segments to form a utility conduit when the modular sections are interconnected, the utility conduit allowing communication between a utility source on the ground and a device requiring the utility when used by a worker at height on the modular ladder; and
a plurality of variable angle connecting members, each variable angle connecting member having a pair of side rail connectors joined to each other by an angle adjusting mechanism, the variable angle connecting members being insertable in pairs between adjacent modular sections so as to adjust an angle between the adjacent modular sections, while maintaining continuity of the utility conduit between the adjacent modular sections, thereby enabling the assembled modular sections joined by said variable angle connectors to be articulated into a plurality of configurations as desired by the user.

12. The modular articulated ladder of claim 11, wherein the variable angle connecting members are able to fix the angle between the adjacent modular sections at any of a plurality of angular settings.

13. The modular articulated ladder of claim 11 further comprising a pair of horizontal struts, each horizontal strut including two segments joined by a limited hinge, the horizontal struts being attachable between a pair of assembled sets of modular sections joined by a pair of variable angle connecting members so as to limit an angle between the pair of assembled sets of modular sections.

14. The modular articulated ladder of claim 11 further comprising a shelf.

15. The modular articulated ladder of claim 14 wherein said shelf provides for storage of tools and materials.

16. The modular articulated ladder of claim 15 wherein said tools and materials are selected from the group consisting of paint, brushes, lacquer, shellac, polyurethane, and paint sprayers.
